(19) United States
(12) Patent Application Publication
(10) Pub. No.: US 2005/0004259 A1
(43) Pub. Date: Jan. 6, 2005

(54) Dyeing formulations

(76) Inventors: Dieter Freyberg, Einselthum (DE); Friedrich-Wilhelm Raulfs, Mannheim (DE); Karl Siemensmeyer, Frankenthal (DE); Mike Freche, Kerzenheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/492,931

(22) PCT Filed: Oct. 22, 2002
(86) PCT No.: PCT/EP02/11784

(30) Foreign Application Priority Data
Oct. 30, 2001 (DE) 101 53 098.6

(51) Int. Cl. C03C 17/00; C09D 5/00

(52) U.S. Cl. 523/160; 523/161

(57) ABSTRACT

The invention concerns dyeing formulations consisting of the following elements: a) at least a dye selected from the group comprising hardly water-soluble dyes a1) and water-soluble dyes a2), b) water, c) in the case of hardly water-soluble dyes a1), at least a dispersant and d) at least a compound of formula (I), wherein the variables are defined as follows: R¹, R² are selected independently of each other from the group consisting of hydrogen, C₁-C₄ alkyl, CH₂—O—R³, R³ representing hydrogen or C₁-C₄ alkyl.

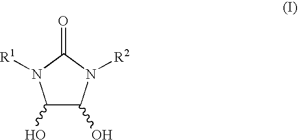

The present invention relates to colorant preparations comprising

a) at least one colorant selected from sparingly water-soluble colorants a1) and water-soluble dyes a2),

b) water,

c) at least one dispersant in the case of substantially water-insoluble or sparingly water-soluble colorants a1), and

d) at least one compound of the general formula I 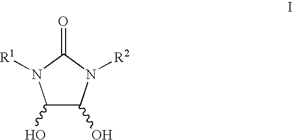
where

R¹ and R² are independently selected from

hydrogen,

C₁-C₄-alkyl and

CH₂—O—R³, where

R³ is hydrogen or C₁-C₄-alkyl.

The invention further relates to the use of these colorant preparations as inks for the ink jet process and to a process for printing sheetlike or three-dimensionally configured substrates in the ink jet process by using these colorant preparations.

Inks for use in the ink jet process (such as Thermal Ink Jet, Piezo Ink Jet, Continuous Ink Jet, Valve Jet) have to meet a whole series of demanding technical requirements. They have to have a viscosity and surface tension suitable for printing, they have to be stable in storage, ie they should not coagulate or flocculate, and they must not lead to cloggage of the printer nozzle, which can be problematical especially in the case of inks containing dispersed, ie undissolved, colorant particles.

Stability in storage further requires of these inks that the dispersed colorant particles do not sediment. Finally, in the case of continuous ink jet the inks shall be stable to the addition of conducting salts and be free from any tendency to flock out with an increase in the ion content. In addition, the prints obtained have to meet colorists' requirements, ie show brilliance and depth of shade, and have good fastnesses, for example rubfastness, lightfastness, waterfastness and wetrubfastness, and good drying characteristics.

WO 99/01516 discloses pigmented ink jet inks whose start-of-print capability and storability are still in need of improvement.

EP-A 1 088 860 discloses aqueous inks which, in addition to a pigment, contain a compound of the general formula II a or II b 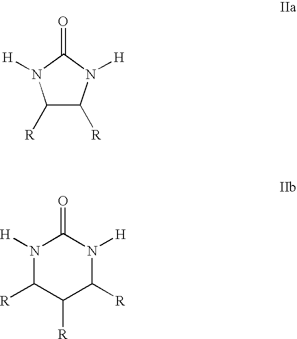
where each R, which may be the same or different, is hydrogen, methyl or ethyl. However, the storability of the disclosed inks is still not sufficient for some purposes.

It is an object of the present invention to provide novel colorant preparations having advantageous application properties in the ink jet process in that they in particular combine good start-of-print and sustained use performance with a good dry time.

We have found that this object is achieved by the colorant preparations defined at the beginning.

The colorant preparations according to the invention may include sparingly water-soluble, dispersed colorant a1) (finely divided organic or inorganic pigments or colorants which are substantially insoluble in the water-solvent mixture) or dissolved colorant a2) (dyes which are soluble in the water-solvent mixture). It will be appreciated that the colorant preparations according to the invention may also include colorant mixtures, but preferably only one colorant is present. Preference is given to colorant preparations according to the invention that are based on pigment. By way of brightening agent, these pigment preparations may include dyes which are similar to the pigment in hue, especially direct, acid or reactive dyes.

There now follow examples of suitable pigments a1), although vat dyes are recited as well because of the overlap with organic pigments.

Organic pigments:

| | |
|---|---|
| monoazo pigments: | C.I. Pigment Brown 25; C.I. Pigment |
| | Orange 5, 13, 36 and 67; C.I. |
| | Pigment Red 1, 2, 3, 5, 8, 9, 12, |
| | 17, 22, 23, 31, 48:1, 48:2, 48:3, |
| | 48:4, 49, 49:1, 52:1, 52:2, 53, |
| | 53:1, 53:3, 57:1, 63, 112, 146, 170, |
| | 184, 210, 245 and 251; C.I. Pigment |
| | Yellow 1, 3, 73, 74, 65, 97, 151 and |
| | 183; |
| disazo pigments: | C.I. Pigment Orange 16, 34 and 44; |
| | C.I. Pigment Red 144, 166, 214 and |
| | 242; C.I. Pigment Yellow 12, 13, 14, |
| | 16, 17, 81, 83, 106, 113, 126, 127, |
| | 155, 174, 176 and 188; |
| anthanthrone pigments: | C.I. Pigment Red 168 (C.I. Vat |
| | Orange 3); |
| anthraquinone pigments: | C.I. Pigment Yellow 147 and 177; |
| | C.I. Pigment Violet 31; |
| anthraquinone pigments: | C.I. Pigment Yellow 147 and 177; |
| | C.I. Pigment Violet 31; |
| anthrapyrimidine pigments: | C.I. Pigment Yellow 108 (C.I. Vat |
| | Yellow 20); |
| quinacridone pigments: | C.I. Pigment Red 122, 202 and 206; |
| | C.I. Pigment Violet 19; |
| quinophthalone pigments: | C.I. Pigment Yellow 138; |
| dioxazine pigments: | C.I. Pigment Violet 23 and 37; |
| flavanthrone pigments: | C.I. Pigment Yellow 24 (C.I. Vat |
| | Yellow 1); |
| indanthrone pigments: | C.I. Pigment Blue 60 (C.I. Vat Blue |
| | 4) and 64 (C.I. Vat Blue 6); |
| isoindoline pigments: | C.I. Pigment Orange 69; C.I. Pigment |
| | Red 260; C.I. Pigment Yellow 139 and |
| | 185; |
| isoindolinone pigments: | C.I. Pigment Orange 61; C.I. Pigment |
| | Red 257 and 260; C.I. Pigment Yellow |
| | 109, 110, 173 and 185; |
| isoviolanthrone pigments: | C.I. Pigment Violet 31 (C.I. Vat |
| | Violet 1); |
| metal complex pigments: | C.I. Pigment Yellow 117, 150 and |
| | 153; C.I. Pigment Green 8; |
| perinone pigments: | C.I. Pigment Orange 43 (C.I. Vat |
| | Orange 7); C.I. Pigment Red 194 |
| | (C.I. Vat Red 15); |
| perylene pigments: | C.I. Pigment Black 31 and 32; C.I. |
| | Pigment Red 123, 149, 178, 179 (C.I. |
| | Vat Red 23), 190 (C.I. Vat Red 29) |
| | and 224; C.I. Pigment Violet 29; |
| phthalocyanine pigments: | C.I. Pigment Blue 15, 15:1, 15:2, |
| | 15:3, 15:4, 15:6 and 16; C.I. |
| | Pigment Green 7 and 36; |
| pyranthrone pigments: | C.I. Pigment Orange 51; C.I. Pigment |
| | Red 216 (C.I. Vat Orange 4); |
| thioindigo pigments: | C.I. Pigment Red 88 and 181 (C.I. |
| | Vat Red 1); C.I. Pigment Violet 38 |
| | (C.I. Vat Violet 3); |
| triarylcarbonium pigments: | C.I. Pigment Blue 1, 61 and 62; C.I. |
| | Pigment Green 1; C.I. Pigment Red |
| | 81, 81:1 and 169; C.I. Pigment |
| | Violet 1, 2, 3 and 27; C.I. Pigment |
| | Black 1 (aniline black); |

C.I. Pigment Yellow 101 (aldazine yellow);

C.I. Pigment Brown 22;

vat dyes (in addition to those already mentioned above):

C.I. Vat Yellow 2, 3, 4, 5, 9, 10, 12, 22, 26, 33, 37, 46, 48, 49 and 50;

C.I. Vat Orange 1, 2, 5, 9, 11, 13, 15, 19, 26, 29, 30 and 31;

C.I. Vat Red 2, 10, 12, 13, 14, 16, 19, 21, 31, 32, 37, 41, 51, 52 and 61;

C.I. Vat Violet 2, 9, 13, 14, 15, 17 and 21;

C.I. Vat Blue 1 (C.I. Pigment Blue 66), 3, 5, 10, 12, 13, 14, 16, 17, 18, 19, 20, 22, 25, 26, 29, 30, 31, 35, 41, 42, 43, 64, 65, 66, 72 and 74;

C.I. Vat Green 1, 2, 3, 5, 7, 8, 9, 13, 14, 17, 26, 29, 30, 31, 32, 33, 40, 42, 43, 44 and 49;

C.I. Vat Brown 1, 3, 4, 5, 6, 9, 11, 17, 25, 32, 33, 35, 38, 39, 41, 42, 44, 45, 49, 50, 55, 57, 68, 72, 73, 80, 81, 82, 83 and 84;

C.I. Vat Black 1, 2, 7, 8, 9, 13, 14, 16, 19, 20, 22, 25, 27, 28, 29, 30, 31, 32, 34, 36, 56, 57, 58, 63, 64 and 65;

inorganic pigments:

| | |
|---|---|
| white pigments: | titanium dioxide (C.I. Pigment White |
| | 6), zinc white, pigment grade zinc |
| | oxide; zinc sulfide, lithopone; lead |
| | white; |
| black pigments: | iron oxide black (C.I. Pigment Black |
| | 11), iron manganese black, spinell |
| | black (C.I. Pigment Black 27); |
| | carbon black (C.I. Pigment Black 7); |
| color pigments: | chromium oxide, chromium oxide |
| | hydrate green; chrome green (C.I. |
| | Pigment Green 48); cobalt green |
| | (C.I. Pigment Green 50); ultramarine |
| | green; cobalt blue (C.I. Pigment |
| | Blue 28 and 36); ultramarine blue; |
| | iron blue (C.I. Pigment Blue 27); |
| | manganese blue; ultramarine violet; |
| | cobalt violet, manganese violet; |
| | iron oxide red (C.I. Pigment Red |
| | 101); cadmium sulfoselenide (C.I. |
| | Pigment Red 108); molybdate red |
| | (C.I. Pigment Red 104); ultramarine |
| | red; |
| | iron oxide brown, mixed brown, |
| | spinell and corundum phases (C.I. |
| | Pigment Brown 24, 29 and 31), chrome |
| | orange; |
| | iron oxide yellow (C.I. Pigment |
| | Yellow 42); nickel titanium yellow |
| | (C.I. Pigment Yellow 53; C.I. |
| | Pigment Yellow 157 and 164); chrome |
| | titanium yellow; cadmium sulfide and |
| | cadmium zinc sulfide (C.I. Pigment |
| | Yellow 37 and 35); chrome, yellow |
| | (C.I. Pigment Yellow 34), zinc |
| | yellow, alkaline earth metal |
| | chromates; Naples yellow; bismuth |
| | vanadate (C.I. Pigment Yellow 184); |
| interference pigments: | metallic effect pigments based on |
| | coated metal platelets; pearl luster |
| | pigments based on mica platelets |
| | coated with metal oxide, liquid |
| | crystal pigments. |

Preferred pigments in this context are monoazo pigments (especially laked BONS pigments, naphthol AS pigments), disazo pigments (especially diaryl yellow pigments, bisacetoacetanilide pigments, disazopyrazolone pigments), quinacridone pigments, quinophthalone pigments, perinone pigments, phthalocyanine pigments, triarylcarbonium pigments (alkali blue pigments, laked rhodamines, dye salts with complex anions), isoindoline pigments and carbon blacks.

Specific examples of particularly preferred pigments are: C.I. Pigment Yellow 138, C.I. Pigment Red 122, C.I. Pigment Violet 19, C.I. Pigment Blue 15:3 and 15:4, C.I. Pigment Black 7, C.I. Pigment Orange 5, 38 and 43 and C.I. Pigment Green 7.

These pigments are advantageously useful for preparing ink jet ink sets based on the colorant preparations according to the invention. The level of the particular pigments in the individual inks must be adapted to the particular requirements (trichromatic coloration, for example).

The following pigment combinations are particularly commendable:

C.I. Pigment Yellow 138, C.I. Pigment Violet 19, C.I. Pigment Blue 15:3 and C.I. Pigment Black 7;

C.I. Pigment Yellow 138, C.I. Pigment Red 122, C.I. Pigment Blue 15:3 or 15:4 and C.I. Pigment Black 7;

C.I. Pigment Yellow 138, C.I. Pigment Violet 19, C.I. Pigment Blue 15:3, C.I. Pigment Black 7, C.I. Pigment Orange 43 and C.I. Pigment Green 7;

C.I. Pigment Yellow 138, C.I. Pigment Red 122, C.I. Pigment Blue 15:3 or 15:4, C.I. Pigment Black 7, C.I. Pigment Orange 5 and C.I. Pigment Green 7;

C.I. Pigment Yellow 138, C.I. Pigment Red 122, C.I. Pigment Blue 15:3 or 15:4, C.I. Pigment Black 7, C.I. Pigment Orange 38 and C.I. Pigment Green 7;

C.I. Pigment Yellow 138, C.I. Pigment Red 122, C.I. Pigment Blue 15:3 or 15:4, C.I. Pigment Black 7, C.I. Pigment Orange 43 and C.I. Pigment Green 7.

Useful dyes a1), which are substantially insoluble in the water-solvent mixture, as well as the vat dyes already mentioned, include in particular azo, anthraquinone, quinophthalone, benzodifuran, methine and azamethine dyes that are free of acidic or ionic groups.

Useful dyes a1) include specifically for example:

C.I. Disperse Yellow 1, 2, 3, 4, 5, 6, 7, 8, 9, 10, 11, 11:1, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 179, 180, 181, 182, 183, 184, 184:1, 198, 200, 201, 202, 203, 204, 205, 206, 207, 208, 209, 210, 211, 212, 213, 214, 215, 216, 217, 218, 219, 220, 221, 222, 223, 224, 225, 226, 227 and 228;

C.I. Disperse Orange 1, 2, 3, 3:3, 4, 5, 6, 7, 8, 9, 10, 11, 12, 13, 14, 15, 16, 17, 18, 19, 20, 21, 22, 23, 24, 25, 25:1, 26, 27, 28, 29, 30, 31, 32, 33, 34, 35, 36, 37, 38, 39, 40, 41, 41:1, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 126, 127, 128, 129, 130, 131, 136, 137, 138, 139, 140, 141, 142, 143, 145, 146, 147 and 148;

C.I. Disperse Red 1, 2, 3, 4, 5, 5:1, 6, 7, 8, 9, 10, 11, 12, 13, 14, 15, 16, 17, 18, 19, 20, 21, 22, 23, 24, 25, 26, 27, 28, 29, 30, 30:1, 31, 32, 33, 34, 35, 36, 38, 39, 40, 41, 43, 43:1, 46, 48, 50, 51, 52, 53, 54, 55, 55:1, 56, 58, 59, 60, 61, 63, 65, 66, 69, 70, 72, 73, 74, 75, 76, 77, 79, 80, 81, 82, 84, 85, 86, 86:1, 87, 88, 89, 90, 91, 92, 93, 94, 96, 97, 98, 100, 102, 103, 104, 105, 106, 107, 108, 109, 110, 111, 112, 113, 115, 116, 117, 118, 120, 121, 122, 123, 125, 126, 127, 128, 129, 130, 131, 132, 133, 134, 135, 136, 137, 138, 139, 140, 141, 142, 143, 144, 145, 146, 147, 148, 149, 150, 151, 151:1, 152, 153, 154, 155, 156, 157, 158, 159, 160, 161, 162, 163, 164, 165, 166, 167, 167:1, 168, 169, 170, 171, 172, 173, 174, 175, 176, 177, 178, 179, 180, 181, 182, 183, 184, 185, 186, 187, 188, 189, 190, 190:1, 191, 191:1, 192, 193, 194, 195, 211, 223, 224, 273, 274, 275, 276, 277, 278, 279, 280, 281, 302:1, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 338, 339, 340, 341, 342, 343, 344, 346, 347, 348, 349, 352, 356 and 367;

C.I. Disperse Violet 1, 2, 3, 4, 4:1, 5, 6, 7, 8, 9, 10, 11, 12, 13, 14, 15, 16, 17, 18, 19, 20, 21, 22, 23, 24, 25, 26, 27, 28, 29, 31, 33, 34, 35, 36, 37, 38, 39, 40, 41, 42, 43, 44, 45, 46, 47, 48, 49, 50, 51, 52, 53., 54, 55, 56, 57, 58, 59, 60, 70, 81, 86, 87, 88, 89, 91, 92, 93, 94, 96 and 97;

C.I. Disperse Blue 1, 1:1, 2, 3, 3:1, 4, 5, 6, 7, 7:1, 8, 9, 10, 11, 12, 13, 13:1, 14, 15, 16, 17, 18, 19, 20, 21, 22, 23, 23:1, 24, 25, 26, 27, 28, 29, 30, 31, 32, 33, 34, 35, 36, 38, 39, 40, 42, 43, 44, 45, 47, 48, 49, 51, 52, 53, 54, 55, 56, 58, 60, 60:1, 61, 62, 63, 64, 64:1, 65, 66, 68, 70, 72, 73, 75, 76, 77, 79, 80, 81, 81:1, 82, 83, 84, 85, 86, 87, 88, 89, 90, 91, 92, 93, 94, 95, 96, 97, 98, 99, 100, 101, 102, 103, 104, 105, 106, 107, 108, 109, 111, 112, 113, 114, 115, 116, 117, 118, 119, 121, 122, 123, 124, 125, 126, 127, 128, 130, 131, 132, 133, 134, 136, 137, 138, 139, 140, 141, 142, 143, 144, 145, 146, 147, 148, 149, 150, 151, 152, 153, 154, 155, 156, 158, 159, 160, 161, 162, 163, 164, 165, 165:2, 166, 167, 168, 169, 170, 171, 172, 173, 174, 175, 195, 281, 282, 283, 283:1, 284, 285, 286, 287, 288, 289, 290, 291, 292, 293, 294, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 349, 351 and 359;

C.I. Disperse Green 1, 2, 5, 6 and 9;

C.I. Disperse Brown 1, 2, 3, 4, 4:1, 5, 7, 8, 9, 10, 11, 18, 19, 20 and 21;

C.I. Disperse Black 1, 3, 4, 5, 6, 7, 8, 9, 10, 11, 12, 13, 14, 15, 20, 22, 24, 25, 26, 27, 28, 29, 29:1, 30, 31, 32, 33, 34 and 36;

C.I. Solvent Yellow 2, 3, 7, 12, 13, 14, 16, 18, 19, 21, 25, 25:1, 27, 28, 29, 30, 33, 34, 36, 42, 43, 44, 47, 56, 62, 72, 73, 77, 79, 81, 82, 83, 83:1, 88, 89, 90, 93, 94, 96, 98, 104, 107, 114, 116, 117, 124, 130, 131, 133, 135, 141, 143, 144, 145, 146, 157, 160:1, 161, 162, 163, 167, 169, 172, 173, 176, 179, 180, 181, 182, 183, 184, 185, 186, 187, 189, 190 and 191;

C.I. Solvent Orange 1, 2, 3, 4, 5, 7, 11, 14, 20, 23, 25, 31A, 40:1, 41, 45, 54, 56, 58, 60, 62, 63, 70, 75, 77, 80, 81, 86, 99, 102, 103, 105, 106, 107, 108, 109, 110, 111, 112 and 113;

C.I. Solvent Red 1, 2, 3, 4, 8, 16, 17, 18, 19, 23, 24, 25, 26, 27, 30, 33, 35, 41, 42, 45, 48, 49, 52, 68, 69, 72, 73, 83:1, 84:1, 89, 90, 90:1, 91, 92, 106, 109, 111, 118, 119, 122, 124, 125, 127, 130, 132, 135, 141, 143, 145, 146, 149, 150, 151, 155, 160, 161, 164, 164:1, 165, 166, 168, 169, 172, 175, 179, 180, 181, 182, 195, 196, 197, 198, 207, 208, 210, 212, 214, 215, 218, 222, 223, 225, 227, 229, 230, 233, 234, 235, 236, 238, 239, 240, 241, 242, 243, 244, 245, 247 and 248;

C.I. Solvent Violet 2, 8, 9, 11, 13, 14, 21, 21:1, 26, 31, 36, 37, 38, 45, 46, 47, 48, 49, 50, 51, 55, 56, 57, 58, 59, 60 and 61;

C.I. Solvent Blue 2, 3, 4, 5, 7, 18, 25, 26, 35, 36, 37, 38, 43, 44, 45, 48, 51, 58, 59, 59:1, 63, 64, 67, 68, 69, 70, 78, 79, 83, 94, 97, 98, 99, 100, 101, 102, 104, 105, 111, 112, 122, 124, 128, 129, 132, 136, 137, 138, 139 and 143;

C.I. Solvent Green 1, 3, 4, 5, 7, 28, 29, 32, 33, 34 and 35;

C.I. Solvent Brown 1, 3, 4, 5, 12, 20, 22, 28, 38, 41, 42, 43, 44, 52, 53, 59, 60, 61, 62 and 63;

C.I. Solvent Black 3, 5, 5:2, 7, 13, 22, 22:1, 26, 27, 28, 29, 34, 35, 43, 45, 46, 48, 49 and 50.

Also suitable are the substituted benzodifuranone dyes which are known per se and whose basic structure conforms to the formula A.

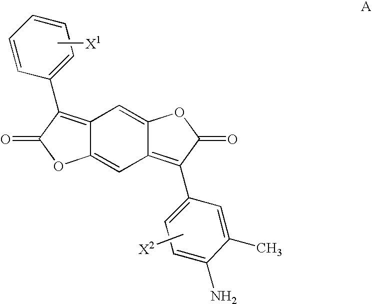

Such dyes may be substituted on either or both of the phenyl rings. Useful substituents X¹ and X² include halogen, alkyl with or without interruption by nonadjacent oxygen atoms, alkoxy with or without interruption by oxygen atoms and substitution in the alkyl moiety, hydroxyl, substituted or unsubstituted amino, cyano, nitro and alkoxycarbonyl.

Useful dyes further include dyes of the following formulae B to E:

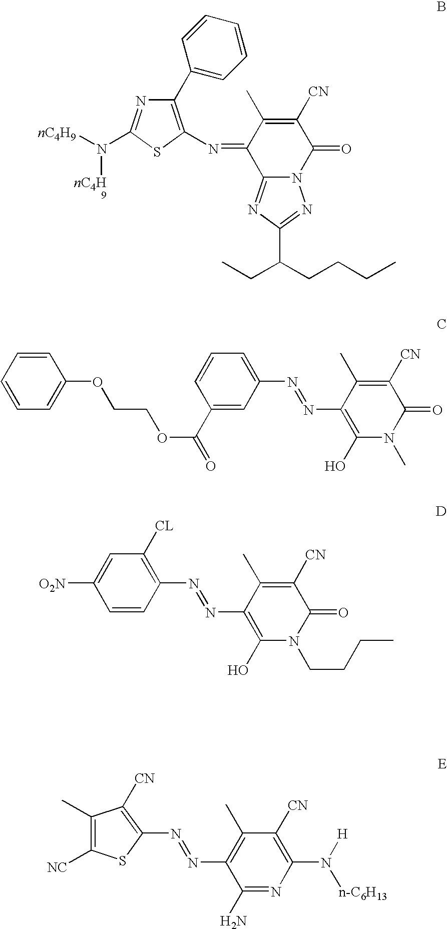

Further examples of insoluble dyes a1) are recited in WO 97/46623, WO 98/24850 and WO 99/29783.

The undissolved, dispersed colorant a1) should be very finely divided. It is preferred for 95% and more preferably 99% of the colorant particles a1) to have an average particle diameter of 1 μm and preferably 0.5 μm.

Useful dyes a2), which are soluble in the water-solvent mixture, include in particular arylmethane, azo, methine, rhodamine and metal complex dyes which contain acidic or ionic groups.

Examples of suitable dyes a2) are specifically:

C.I. Basic Yellow 2, 37, 78, 94, 96, 97, 98, 102 and 111;

C.I. Basic Orange 2, 60, 62 and 63;

C.I. Basic Red 1, 14, 49, 108 and 111;

C.I. Basic Violet 1, 3, 4, 10, 11, 49 and 50;

C.I. Basic Blue 26, 152, 157, 158 and 161;

C.I. Basic Green 1 and 4;

C.I. Basic Brown 1;

C.I. Acid Orange 7 and 8;

C.I. Acid Blue 9;

C.I. Direct Yellow 4, 5, 11, 15, 127, 131 and 147;

C.I. Direct Red 239 and 254;

C.I. Direct Blue 161, 199, 279 and 281;

C.I. Reactive Red 120.

The colorant preparations according to the invention generally include from 0.01 to 20% by weight, and preferably from 0.2 to 10% by weight and more preferably from 1 to 6% by weight of colorant a), particularly suitable amounts in the case of colorant a1) ranging from 1 to 6% by weight and in the case of colorant a2) ranging from 1 to 10% by weight.

Water is the main constituent b) of the colorant preparations according to the invention, preference being given to demineralized, completely ion-free water as obtainable for example through the use of an ion exchanger. The water content is customarily in the range from 50 to 95% by weight. The preparations according to the invention preferably have a water content of from 60 to 80% by weight. In fact, the water content is preferably in the range from 60 to 80% by weight in the case of binder-free preparations and in the range from 50 to 75% by weight in the case of binder-containing preparations.

When the colorant preparations according to the invention are based on undissolved colorants a1), they will generally include from 0.1 to 25% by weight and preferably from 0.5 to 10% by weight of at least one dispersant c). In the case of dissolved colorants a2), component c) is customarily omitted.

Useful dispersants c) include in principle all dispersants known for aqueous systems.

Particularly useful dispersants are water-soluble dispersants based on one or more water-soluble alkoxylated phenols C 1, one or more arylsulfonic acid-formaldehyde condensation products C 2, one or more condensation products of an at least difunctional isocyanate with compounds C 3 each bearing one isocyanate-reactive group or one or more alkoxylated hydroxynaphthalenes C 4.

Useful dispersants C 1 include alkoxylated phenols of the formula C 1a, 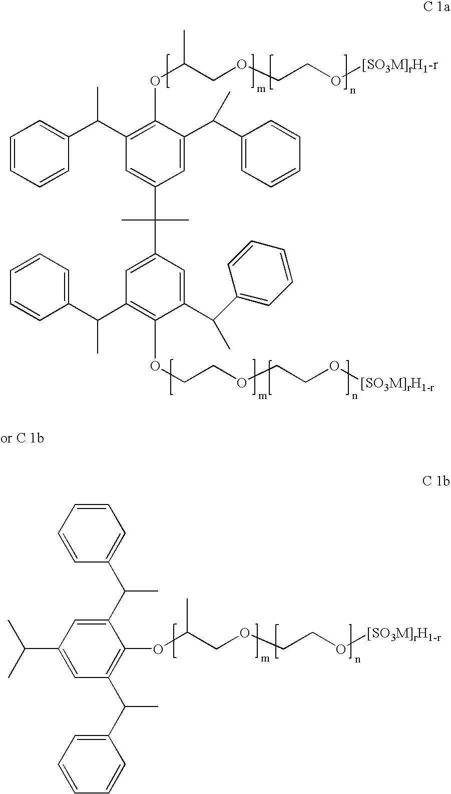
where

m is between 0 and 180, preferably between 0 and 125

n is between 10 and 180, n is preferably at least 25 and particularly preferably at least 37, subject to the proviso that n≧m;

M is an alkali metal, preferably Na or K and particularly preferably Na;

r is 0 or 1, or mixtures thereof.

The compounds C 1a and C 1b are advantageously prepared by reacting the phenols C 1a.1 or C 1a.2 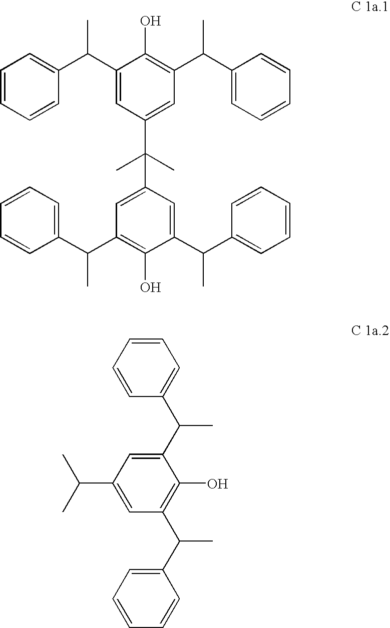
with propylene oxide and subsequently reacting the adduct with ethylene oxide or by reacting C 1a.1 or C 1a.2 with ethylene oxide. The adducts may subsequently be reacted with chlorosulfonic acid or sulfur trioxide to convert them completely or partially into acid sulfuric esters and the resulting acid esters are neutralized with alkalis.

The phenols of the formulae C 1a.1 and C 1a.2 are obtainable by reacting bisphenol A (2,2-(p,p′-bishydroxydiphenyl)propane) or phenol with respectively 4 or 2 mol of styrene in the presence of an acid as a catalyst. The phenols C 1a.1 and C 1a.2 are reacted according to known processes first with propylene oxide and then with ethylene oxide or only with ethylene oxide in the presence of acidic or alkaline catalysts, for example NaOCH₃ or SbCl₅, to form the respective corresponding alkoxylation products C 1a and C 1b where r=0. The alkoxylation may be carried out for example according to the process described in U.S. Pat. No. 2,979,528.

The acid sulfuric esters are prepared by reaction of the alkoxylation products with chlorosulfonic acid or sulfur trioxide, the amount of chlorosulfonic acid or sulfur trioxide being selected so that all the free hydroxyl groups or only a certain portion thereof is sulfated. The latter case produces mixtures of compounds of the formulae C 1a and C 1b, which contain free and sulfated hydroxyl groups. For use as a dispersant, the as-synthesized acid esters of sulfuric acid are converted into water-soluble salts. Advantageous water-soluble salts are the alkali metal salts, for example the sodium or potassium salts. For this two equivalents of the basic compounds are required in the case of chlorosulfonic acid, one equivalent in the case of sulfur trioxide. The basic compound used is advantageously an aqueous alkali metal hydroxide. The neutralization temperature should not exceed 70° C. The salts obtained can be used in the form of aqueous solutions or else isolated as such and used in solid form.

Preference is given to dispersants C 1 where m is from 0 to on average 2.5, n is on average from 37 to 250 and r is on average from 0 to on average 0.5. Particular preference is given to dispersants C 1 where a is from 0 to on average 2.5, b is on average from 50 to 100 and d is on average 0.5.

The dispersants C 1 are known and described for example in U.S. Pat. No. 4,218,218.

The dispersants C 2 are obtainable by sulfonation of aromatic compounds such as naphthalene itself or of naphthalene-comprising mixtures and subsequent condensation of the resultant arylsulfonic acids with formaldehyde.

The preferred starting material for preparing the arylsulfonic acids was the mixture of aromatic compounds which is characterized in Table 1 and which was obtained by thermal cracking of a naphthenic residue oil at from 1400 to 1700° C. and fractionation of the cracking products (fraction which passes over at 1013 mbar and 100-120° C.). These naphthenic residue oils are obtained in the cracking of light gasoline and are also referred to as high boiling aromatic hydrocarbon oils.

This aromatics fraction is a mixture of a multiplicity of aromatic substances whose structure and amount is practically impossible to determine in any detail. The following aryl compounds are the most important representatives of this aromatics fraction:

TABLE 1

| | % by weight in |
|---|---|
| | aromatics fraction |
| Naphthalene | 30-55 |
| 2-Methylnaphthalene | 5-15 |
| 1-Methylnaphthalene | 4-10 |
| Indene | 3-10 |
| Biphenyl | 1-5 |
| Methylindene | 1-5 |
| Acenaphthene | 1-4 |

The aromatics fraction further includes, in terms of identified constituents, in amounts from 0.1 to about 2% by weight, the following aromatic compounds: fluorene, indan, α-methylstyrene, phenanthrene, methylindan, dimethylnaphthalene, ethylnaphthalene, xylenes, tetralin, styrene, methylethylbenzene, anthracene, fluoranthrene, pyrene and toluene.

The dispersant C 2 may be prepared in the presence of aromatic or long-chain aliphatic carboxylic acids, their salts, anhydrides or mixtures.

Examples of suitable aromatic carboxylic acids and derivatives thereof are naphthalenecarboxylic acid, phthalic acid, terephthalic acid, isophthalic acid, benzoic acid, trimellitic acid, phenylacetic acid, phenoxyacetic acid, salicylic acid, p-hydroxybenzoic acid, diphenylacetic acid, m-hydroxybenzoic acid, benzenetetracarboxylic acid or acid anhydrides such as trimellitic anhydride, benzene-1,2,4,5-tetracarboxylic dianhydride or phthalic anhydride.

Suitable long-chain aliphatic carboxylic acids include in particular saturated or olefinically unsaturated, linear or branched aliphatic monocarboxylic acids having from 8 to 22, preferably from 8 to 18, carbon atoms of a natural or synthetic origin, for example higher fatty acids such as lauric acid, myristic acid, palmitic acid, stearic acid, oleic acid, linoleic acid or linolenic acid or synthetically produced carboxylic acids such as 2-ethylhexanoic acid, isononanoic acid or isotridecanoic acid.

Suitable salts of the carboxylic acids mentioned are the alkali metal, ammonium or alkaline earth metal salts, said alkali metal, ammonium or alkaline earth metal salts being obtainable, for example, by neutralization of the corresponding carboxylic acids with sodium hydroxide, potassium hydroxide, lithium hydroxide, sodium carbonate, magnesium carbonate, calcium oxide, calcium hydroxide, ammonia or alkanolamines such as ethanolamine, diethanolamine or triethanolamine.

Preference is given to sodium benzoate, sodium phenylacetate, sodium salicylate, sodium 4-hydroxybenzoate, sodium terephthalate, sodium 2-hydroxy-3-naphthalenecarboxylate, naphthalene-1-carboxylic acid, phthalic anhydride or benzoic acid.

Dispersants C 2 which are particularly suitable in this case comprise from 50 to 97% by weight, especially from 70 to 95% by weight, of arylsulfonic acid-formaldehyde condensation products and from 3 to 50% by weight, especially from 5 to 30% by weight, of aromatic or long-chain aliphatic carboxylic acids, their salts or anhydrides or mixtures thereof.

These mixtures are initially sulfonated by reaction with concentrated sulfuric acid or with oleum having an SO₃ content of from 10 to 65% by weight at from 120-160° C. and preferably at 135-145° C. Per part by weight of the aromatics it is advantageous to use from 0.7 to 1.5 parts by weight of oleum having an SO₃ content of 65% by weight or a corresponding amount of oleum having a lower SO₃ content. The reaction time is customarily in the range from 1.5 to 3 hours at 145° C., in the range from 2¼ to 4 hours at 140° C. and in the range from 3¼ to 6 hours at 135° C.

After sulfonation, the arylsulfonic acid mixtures contain at least 50% by weight of a mixture of α- and β-naphthalenesulfonic acids, the ratio of the α- to the β-isomers being customarily in the range from 20:1 to 1:8, especially in the range from 10:1 to 1:5 and most preferably in the range from 1:1 to 1:2.

The sulfonated products are subsequently condensed with formaldehyde. This is generally effected by diluting the reaction mixture of the sulfonation reaction with water and then adding formaldehyde, preferably in the form of an aqueous solution from 10 to 50% by weight in strength. The mixture thus formed is maintained at from 90 to 105° C. for from 4 to 12 and preferably from 7 to 9 hours. When elevated pressure is employed, for example in the range from 1.1 to 10 bar, it is also possible to use reaction temperatures in the range from 105 to 150° C. It is customary to use from 0.05 to 0.2 and preferably from 0.07 to 0.17 part by weight of formaldehyde, based on sulfonation products.

After the reaction has ended, the reaction mixture is customarily neutralized, for example with sodium hydroxide, potassium hydroxide, calcium hydroxide, sodium carbonate, potassium carbonate or sodium bicarbonate, in the form of the aqueous solutions, until the pH is in the range from 6 to 11.

The condensation products obtained from the abovementioned aromatics fraction have a sulfonic acid group content of not more than 40% by weight. The production process is such that the condensation products may additionally contain up to 10% by weight of Na₂SO₄ and up to 25 mol % of sulfuric acid, based on sulfonic acid groups.

The dispersants C 2 and their preparation are known; cf. for example U.S. Pat. No. 5,186,846, DE-A-11 37 005 or EP-A-380 778.

The dispersants C 3 are condensation products of at least difunctional isocyanates, which serve as point of attachment, with a polymeric compound (hereinafter referred to as stabilizer block) which is terminated at one end by an isocyanate-reactive group and which makes solid particles to be dispersed compatible with the dispersion medium, and an anchor group block, which can be either a homo- or copolymer of a nitrogenous monomer or a phosphonic ester, which each possess an isocyanate-reactive group and which each sorb onto the solid particles to be dispersed.

The isocyanate connecting the stabilizer block and the anchor group block is a diisocyanate or a more highly functional polyisocyanate having an average NCO functionality of from 2.0 to 4.5.

The diisocyanates can be aromatic or aliphatic, preference being given to aliphatic diisocyanates, such as tetramethylene diisocyanate, hexamethylene diisocyanate, octamethylene diisocyanate, decamethylene diisocyanate, dodecamethylene diisocyanate, tetradecamethylene diisocyanate, trimethylhexane diisocyanate or tetramethylhexane diisocyanate, 1,4-, 1,3- or 1,2-diisocyanatocyclohexane, 4,4′-di(isocyanatocyclohexyl)-methane, 1-isocyanato-3,3,5-trimethyl-5-(isocyanatomethyl)cyclohexane (isophorone diisocyanate) or 2,4- or 2,6-diisocyanato-1-methylcyclohexane, particular preference being given to hexamethylene diisocyanate and isophorone diisocyanate.

The higher polyisocyanates may likewise be aromatic or aliphatic. Here too preference is given to aliphatic polyisocyanates, especially those having an average NCO functionality of from 1.7 to 5, especially about 3. The following groups are mentioned by way of example:

(a) Isocyanurate group containing polyisocyanates of aliphatic and/or cycloaliphatic diisocyanates. Particular preference is given here to the corresponding isocyanato-isocyanurates based on hexamethylene diisocyanate and isophorone diisocyanate. These isocyanurates are in particular simple trisisocyanatoalkyl or trisisocyanatocycloalkyl isocyanurates, which are cyclic trimers of the diisocyanates, or mixtures with their higher homologs containing more than one isocyanurate ring. The isocyanato-isocyanurates generally have an NCO content of from 10 to 30% by weight, in particular from 15 to 25% by weight, and an average NCO functionality of from 2.6 to 4.5.

(b) Uretdione diisocyanates having aliphatically and/or cycloaliphatically attached isocyanate groups, which are preferably derived from hexamethylene diisocyanate or isophorone diisocyanate. Uretdione diisocyanates are cyclic dimerization products of diisocyanates.

(c) Biuret group containing polyisocyanates having aliphatically attached isocyanate groups, especially tris(6-isocyanato-hexyl)biuret or its mixtures with its higher homologs. These biuret group containing polyisocyanates generally have an NCO content of from 18 to 25% by weight and an average NCO functionality of from 3 to 4.5.

(d) Urethane and/or allophanate group containing polyisocyanates having aliphatically or cycloaliphatically attached isocyanate groups, as are obtainable for example by reaction of excess amounts of hexamethylene diisocyanate or of isophorone diisocyanate with simple polyhydric alcohols, such as trimethylolpropane, glycerol, 1,2-dihydroxypropane or mixtures thereof. These urethane and/or allophanate group containing polyisocyanates generally have an NCO content of from 12 to 20% by weight and an average NCO functionality of from 2.5 to 3.

(e) Oxadiazinetrione group containing polyisocyanates, preferably derived from hexamethylene diisocyanate or isophorone diisocyanate. Such oxadiazinetrione group containing polyisocyanates are preparable from diisocyanate and carbon dioxide.

(f) Uretoneimine-modified polyisocyanates.

The polymeric compound forming the stabilizer block is preferably a polymeric compound of the general formula C 3a
R⁵—Yₓ—XH C 3a
where

R⁵ is hydrogen,

C₁-C₂₈-alkyl, preferably C₁-C₁₀-alkyl, for example methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, iso-heptyl, n-octyl, n-nonyl and n-decyl; preferably C₁-C₆-alkyl such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethyl-propyl, iso-amyl, n-hexyl, iso-hexyl, sec-hexyl, particularly preferably C₁-C₄-alkyl such as methyl, ethyl, n-propyl, iso-propyl, n-butyl, iso-butyl, sec-butyl and tert-butyl.

C₂-C₂₈-alkenyl having one or more double bonds, substituted or unsubstituted, for example vinyl, 1-allyl, 3-allyl, ω-butenyl, ω-pentenyl, ω-hexenyl, ω-decenyl, ω-undecenyl, ω-eicosenyl, 1-cis-buta-1,3-dienyl or 1-cis-hexa-1,5-dienyl. Examples of substituted C₂-C₂₈-alkenyl groups are isopropenyl, 1-isoprenyl, α-styryl, β-styryl, 1-cis-1,2-phenylethenyl or 1-trans-1,2-phenylethenyl.

C₂-C₂₈-alkynyl having one or more triple bonds, substituted or unsubstituted and optionally having double bonds, for example ethynyl, propargyl, ω-butynyl, but-2-ynyl, ω-pentynyl, pent-2-ynyl, pent-3-ynyl, 2-methylpent-3-ynyl, ω-hexynyl, ω-decynyl, ω-undecynyl, ω-eicosynyl,

or the residue of a polymerization initiator or of a chain regulator,

Y represents identical or different polymerized units of monomers selected from the group consisting of α,β-ethylenically unsaturated mono- or-dicarboxylic acids; unsubstituted or hydroxyl-, C₁-C₆-alkoxy-, polyalkylenoxy- or halogen-mono- or -polysubstituted C₁-C₂₀-(cyclo)alkyl or C₇-C₂₀-aralkyl esters, amides, nitriles or anhydrides of α,β-ethylenically unsaturated mono- or dicarboxylic acids; vinyl or allyl esters of aliphatic or aromatic carboxylic acids; vinyl or allyl ethers; ethylenically unsaturated sulfonic acids or sulfonic acid derivatives, halogenated or unhalogenated ethylenically unsaturated aliphatic C₂-C₂₀ hydrocarbons; aromatic ethylenically unsaturated compounds and compounds polymerizable to form polyphosphacenes; or is 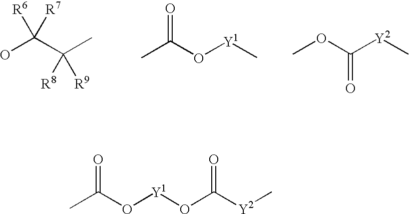
where

R⁶ to R⁹ are independently hydrogen,

C₁-C₆-alkyl, for example methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, particularly preferably C₁-C₄-alkyl such as methyl, ethyl, n-propyl, iso-propyl, n-butyl, iso-butyl, sec-butyl and tert-butyl.

C₆-C₂₀-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl,

—CH₂—Cl or —CH₂—OH,

and Y¹, Y² are independently a C₂-C₂₀-alkylene, C₆-C₁₄-arylene such as for example p-phenylene or m-phenylene or aralkylene group,

x is an integer between 0 and 10,000, preferably 3 2, especially 3 3 and particularly preferably in the range from 30 to 1000, and

X is COO, O, S or NR¹⁰, where R¹⁰ is H or a C₁-C₆-alkyl group as defined above.

The polymeric compound C 3a is preferably constructed using C₁-C₈-alkyl (meth)acrylates. Particular preference is given to polymerizing one or more C₁-C₄-alkyl methacrylates, especially methyl methacrylate and/or butyl methacrylate. The isocyanate-reactive group XH is preferably a hydroxyl group which may be introduced into the terminal position of the polyacrylate with the aid of initiators which provide a hydroxyl free radical on decomposition and/or with the aid of chain regulators which contain a hydroxyl group.

The polymeric compound C 3a is most preferably a mono(generally C₁-C₁₈, preferably C₁-C₄)alkyl ether of a poly (especially C₂-C₄)alkylene glycol, which may be obtained for example by reacting an alkanol with an alkene oxide, such as ethylene oxide, propylene oxide and butylene oxide, or epichlorohydrin. Of particular suitability are C₁-C₁₈ (especially C₁-C₄) alkanols alkoxylated with from 5 to 10,000, preferably from 5 to 80, mol of ethylene oxide and/or propylene oxide, and polyethylene glycol monomethyl ethers are very particularly useful.

The weight average molecular weight of the stabilizer block is preferably within the range from about 250 to 100,000, especially within the range from about 500 to 7000.

An anchor group block embodiment useful for constructing the dispersant c3) is based on homo- or copolymers of one or more monomers selected from the group consisting of N-vinylamides, N-vinyllactams and vinyl-or allyl-substituted nitrogenous heterocycles. Examples of particularly useful monomers are N-vinylpyrrolidone, N-vinylpyridine, N-vinylcaprolactam, N-vinylimidazole and N-vinylformamide, of which N-vinyl-pyrrolidone is preferred. The homo- or copolymer preferably has a K value of from 10 to 100, especially from 10 to 30. Termination in the form of a hydroxyl group as isocyanate-reactive group may be accomplished by conducting the polymerization in water or a lower alcohol such as isopropanol or by polymerization in the presence of an appropriate chain regulator and/or initiator.

A further anchor group block embodiment useful for constructing the dispersant c3) is formed by phosphonic esters of the general formula C 3b 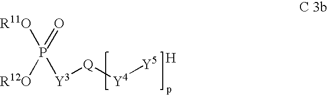
where

R¹¹ and R¹² are independently C₁-C₄-alkyl such as methyl, ethyl, n-propyl, iso-propyl, n-butyl, iso-butyl, sec-butyl and tert-butyl, especially R¹¹=R¹²=methyl or ethyl;

Q is NR₍₂₋ₚ₎ or CR₍₃₋ₚ₎ (R═H or C₁-C₈-alkyl);

Y³ and Y⁴ are independently a chemical bond or unsubstituted or C₁-C₈-alkyl- or aryl-substituted C₁-C₁₀-alkylene with or without interruption by one or more O, NR, CO, COO, OCO, CONR or NRCO;

p is 1 or 2; and

Y⁵ is COO, O, S or NR¹³, where R¹³ is H or a C₁-C₆-alkyl group as defined above.

Preferred examples of these phosphonic esters are diethyl N,N-bis(hydroxyethyl)aminomethylphosphonate, the dimethyl or diethyl esters of 3-hydroxymethylamino-3-oxopropylphosphonic acid, 3-aminopropylphosphonic acid, 1-aminopropylphosphonic acid, 2-aminooctylphosphonic acid, 1-aminooctylphosphonic acid, 1-aminobutylphosphonic acid, hydroxymethylphosphonic acid and 1-hydroxyethylphosphonic acid.

The reaction of the di- or polyisocyanate with the stabilizer block and the anchor group block can take place in two steps or in a one-pot reaction. Preferably, however, the reaction takes place in two steps where the di- or polyisocyanate is reacted with the stabilizer block in the first step. The reaction can take place in the absence or presence of a solvent, preference being given to the reaction in the presence of a solvent, such as acetone, THF, toluene, dioxane. When the stabilizer block has been prepared by polymerization of an ethylenically unsaturated compound, the reaction of the stabilizer block with the di- or polyisocyanate can advantageously be carried out in the same solvent as the free-radical polymerization. The reaction can be carried out without catalyst or preferably in the presence of a catalyst, such as a tertiary amine, especially triethylamine, or a metal salt, especially tin octoate or lead octoate, or an organometallic compound, such as dibutyltin dilaurate or titanium tetramethoxide. The reaction is generally carried out at a temperature from room temperature to 125° C., especially within the range from 40 to 90° C.

Further details concerning dispersants C 3 are described in DE-A-198 429 52.

Dispersants C 4 are alkoxylated hydroxynaphthalenes, preferably ethoxylated β-hydroxynaphthalenes. Dispersants c4) generally have an average molecular weight M_{w} of from 2000 to 40 000 g/mol, especially from 20 000 to 35 000 g/mol, and particularly from 25 000 to 30 000 g/mol.

Dispersants C 4 are generally known and available in a customary manner by alkoxylation of hydroxynaphthalene.

The colorant preparations according to the invention further include at least one compound of the general formula I 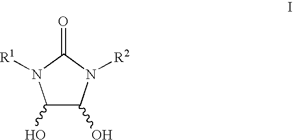
where

R¹ and R² are independently selected from hydrogen, C₁-C₄-alkyl, for example methyl, ethyl, n-propyl, isopropyl, n-butyl, isobutyl, sec-butyl and tert-butyl; CH₂—O—R³, where

R³ is hydrogen or C₁-C₄-alkyl selected from methyl, ethyl, n-propyl, isopropyl, n-butyl, isobutyl, sec-butyl and tert-butyl.

Preferably R¹ and R² are the same. Most preferably R¹ and R² are the same and are each selected from hydrogen or methyl or CH₂OH.

Illustrative representatives of the compounds of the general formula I are obtainable as follows:

Compound I a 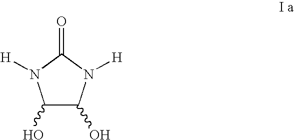
is advantageously preparable in a known manner by condensing glyoxal with one equivalent of urea in the presence of an alkali, as reported for example in R. Wegler et al., Methoden Org. Chem. (Houben-Weyl), volume 14/2, page 341, Thieme Verlag Stuttgart, 1963 and the references cited therein.

Compound I b 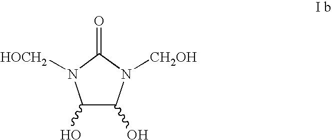
is obtainable for example by adding two or more equivalents of formaldehyde under similar conditions. Alternatively, compound I b is obtainable by reacting glyoxal with formaldehyde and urea at pH 5.5 as described in GB 1,273,517.

Compound I c 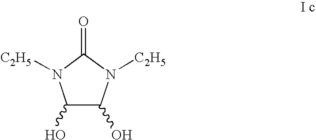
and other symmetrical and asymmetrical derivatives are obtainable by a method from Russ. Chem. Bull. 1998, 47, 1561 and the references cited therein.

The compounds of the general formula I are customarily obtained as an isomeric mixture of cis- and trans-diols. The present invention can be performed using pure cis-diol, pure trans-diol or else isomeric mixtures.

The compounds of the general formula I are customarily added in amounts from 0.1 to 20% by weight, based on the colorant preparation.

The colorant preparations according to the invention may include organic solvents as a further component. Low molecular weight polytetrahydrofuran is a preferred additive, and it can be used alone or preferably in a mixture with one or more high-boiling water-soluble or water-miscible organic solvents.

The polytetrahydrofuran whose use is preferred customarily has an average molecular weight M_{w} of from 150 to 500 g/mol, preferably from 200 to 300 g/mol and particularly preferably of about 250 g/mol (corresponding to a molecular weight distribution of from 225 to 275 g/mol; Poly-THF 25.0, BASF Aktiengesellschaft).

Polytetrahydrofuran is preparable in a conventional manner by cationic polymerization of tetrahydrofuran. This produces linear polytetramethylene glycols.

When polytetrahydrofuran is present in a mixture with further organic solvents, the invention provides that the solvents used be high-boiling (ie, boiling point generally >100° C.) and hence water-retaining organic solvents that are soluble in or miscible with water.

Useful solvents include polyhydric alcohols, preferably branched or unbranched polyhydric alcohols containing from 2 to 8, especially from 3 to 6, carbon atoms, such as ethylene glycol, 1,2- and 1,3-propylene glycol, glycerol, erythritol, pentaerythritol, pentitols such as arabitol, adonitol and xylitol and hexitols such as sorbitol, mannitol and dulcitol.

Useful solvents further include polyethylene glycols and polypropylene glycols, which terms also comprehend the lower polymers (di-, tri- and tetramers), and their monoalkyl (especially C₁-C₆-alkyl and in particular C₁-C₄-alkyl) ethers. Preference is given to polyethylene glycols and polypropylene glycols having average molecular weights of from 100 to 1500 g/mol, especially from 200 to 800 g/mol, in particular from 300 to 500 g/mol. Specific examples are di-, tri- and tetraethylene glycol, diethylene glycol monomethyl, monoethyl, monopropyl and monobutyl ethers, triethylene glycol monomethyl, monoethyl, monopropyl and monobutyl ethers, di-, tri- and tetra-1,2- and -1,3-propylene glycol and di-, tri- and tetra-1,2- and -1,3-propylene glycol monomethyl, monoethyl, monopropyl and monobutyl ethers.

Useful solvents further include pyrrolidone and N-alkylpyrrolidones whose alkyl chain preferably contains from 1 to 4 and especially 1 or 2 carbon atoms. Examples of useful alkylpyrrolidones are N-methylpyrrolidone, N-ethylpyrrolidone and N-(2-hydroxyethyl)pyrrolidone.

Examples of particularly preferred solvents are 1,2-propylene glycol, 1,3-propylene glycol, glycerol, sorbitol, diethylene glycol, polyethylene glycol (M_{w} 300-500 g/mol), diethylene glycol monobutyl ether, triethylene glycol monobutyl ether, pyrrolidone, N-methylpyrrolidone and N-(2-hydroxyethyl)pyrrolidone.

Polytetrahydrofuran may also be mixed with one or more (eg two, three or four) of the above-recited solvents.

The colorant preparations according to the invention generally include from 0.1 to 40% by weight, preferably from 5 to 30% by weight, more preferably from 10 to 25% by weight and most preferably from 10 to 20% by weight of a solvent component.

The solvent components, including especially the particularly preferred solvent combinations mentioned, can advantageously be supplemented with urea (generally from 0.5 to 3% by weight, based on the weight of the colorant preparation) to further enhance the water-retaining effect of the solvent mixture.

The colorant preparations according to the invention may include further assistants of the type which are customary especially for aqueous ink jet inks and in the printing and coatings industry. Examples of such assistants include preservatives such as for example 1,2-benzisothiazolin-3-one (commercially available as Proxel® brands from Avecia Lim.) and its alkali metal salts, glutaraldehyde and/or tetramethylolacetylenediurea, Protectols®, antioxidants, degasers/defoamers such as for example acetylenediols and ethoxylated acetylenediols, which customarily contain from 20 to 40 mol of ethylene oxide per mole of acetylenediol and may also have a dispersing effect, viscosity regulators, flow agents, wetters (eg wetting surfactants based on ethoxylated or propoxylated fatty or oxo alcohols, propylene oxide-ethylene oxide block copolymers, ethoxylates of oleic acid or alkylphenols, alkylphenol ether sulfates, alkylpolyglycosides, alkyl phosphonates, alkylphenyl phosphonates, alkyl phosphates, alkylphenyl phosphates or preferably polyether siloxane copolymers, especially alkoxylated 2-(3-hydroxypropyl)hepta-methyltrisiloxanes, which generally have a block of from 7 to 20 and preferably of from 7 to 12 ethylene oxide units and a block of from 2 to 20 and preferably of from 2 to 10 propylene oxide units and may be present in the colorant preparations in amounts from 0.05 to 1% by weight), anti-settlers, luster improvers, lubricants, adhesion improvers, anti-skinning agents, delustrants, emulsifiers, stabilizers, hydrophobicizers, light control additives, hand improvers, antistats, bases such as for example triethanolamine or acids, specifically carboxylic acids such as for example lactic acid or citric acid for regulating the pH. When such assistants are part of the pigment preparations according to the invention, their total amount is generally 2% by weight and especially 1% by weight, based on the weight of the colorant preparation.

Binder-free colorant preparations according to the invention customarily have a dynamic viscosity of from 1 to 7 mm²/sec, preferably of up to 5 mm²/sec and especially from 1 to 3 mm²/sec. Binder-containing colorant preparations according to the invention have a dynamic viscosity which is generally in the range from 1 to 25 mm²/sec, preferably in the range from 1 to 15 mm²/sec and especially in the range from 1 to 10 mm²/sec.

The surface tension of the binder-free or binder-containing colorant preparations according to the invention is generally in the range from 24 to 70 mN/m and especially in the range from 30 to 60 mN/m.

The pH of the colorant preparations according to the invention is generally in the range from 5 to 10 and preferably in the range from 7 to 9.

Colorant preparations according to the invention which are based on undissolved colorant a1) are advantageously prepared as follows:

The colorant a1), for example in the form of an aqueous presscake, is mixed together with the dispersant c) in the presence of water and dispersed in a suitable apparatus. The resulting mixture is then ground in a mill to the desired particle size distribution (generally 1 μm on average, preferably 0.5 μm on average). After the desired colorant concentration has been set by addition of solvent, water and optionally further assistants, the preparation is filtered using a filtering means with fines removal in the range from 1 to 0.5 μm.

The particularly suitable starting material for preparations of dissolved dye a2) is relatively highly concentrated dye solutions, for example from 10 to 30% by weight liquid bands of dyes. These are optionally demineralized and filtered (eg nanofiltration) before the desired dye concentration is set.

A further aspect of the present invention is a process for printing sheetlike or three-dimensional substrates by the ink jet process using the colorant preparations according to the invention. To this end, the colorant preparations according to the invention or the ink jet inks according to the invention are printed onto the substrate and the print obtained is then optionally fixed.

In the ink jet process, the typically aqueous inks are sprayed as small droplets directly onto the substrate. There is a continuous form of the process, in which the ink is pressed at a uniform rate through a nozzle and the jet is directed onto the substrate by an electric field depending on the pattern to be printed, and there is an interrupted or drop-on-demand process, in which the ink is expelled only where a colored dot is to appear, the latter form of the process employing either a piezoelectric crystal or a heated hollow needle (bubble or thermal jet process) to exert pressure on the ink system and so eject an ink droplet. These techniques are described in Text. Chem. Color 19 (1987), No. 8, 23-29, and 21 (1989), No. 6, 27-32.

The colorant preparations of-the invention are particularly useful as inks for the bubble jet process or the process employing a piezoelectric crystal.

A further aspect of the present invention is a process for printing substrates by the ink jet process using the colorant preparations according to the invention with subsequent fixing of the print. The fixing can be achieved in various ways.

In one embodiment of the present invention, the actual printing with the colorant preparations according to the invention by the ink jet process is followed by application of a binder in the form of a dispersion or emulsion, preferably in the form of an aqueous dispersion or emulsion, before effecting its curing, ie the chemical crosslinking of the binder itself, or before effecting the physical drying of the binder dispersion or emulsion.

In a further embodiment of the present invention, the actual printing with the colorant preparations according to the invention by the ink jet process is followed by the lamination onto the print of a film, for example of polyethylene terephthalate, to protect the print against water and light in particular.

The binder may in principle be applied using any process whereby a structured or unstructured coating can be produced. Examples of such processes include in particular the techniques of screen printing, padding and spraying and other, uniform-coating techniques such as roller coating, offset printing, flexographic printing and casting.

The print may in principle be fixed using any kind of binder system, if the binder is applied after the actual printing.

It is possible to use radiation-curable, thermally curable or air-drying binders (ie chemically crosslinking binders) or physically drying binder dispersions or emulsions where the liquid phase (water or organic solvent) evaporates.

Radiation-curable binders for the purposes of the present invention are binders which are curable by radiation of high energy, ie electromagnetic radiation especially from 220 to 450 nm, or electron beams. It is possible to use not only free-radically but also cationically polymerizable binder components and also mixtures thereof. Such binders are common knowledge and described, for example, in Chemistry & Technology of UV & EB Formulation for Coatings, Inks & Paints, SITA Technology, London (1991), UV & EB Curing Formulation for Printing Inks and Paints, SITA Technology, London (1984) and in the BASF publication Vinyl Ethers, The Innovative Challenge (1997).

Examples of such radiation-curable binders include acrylate, vinyl and epoxy monomers, prepolymers and polymers and mixtures thereof.

Acrylate binders are especially prepolymers based on acrylate or methacrylate, acrylate-based prepolymers being particularly preferred.

Preferred (meth)acrylate compounds generally contain from 2 to 20, especially from 2 to 10, in particular from 2 to 6, copolymerizable, ethylenically unsaturated double bonds. The number average molecular weight Mₙ is preferably ≦15,000, particularly preferably ≦5000, very particularly preferably within the range from 180 to 3000 g (determined by gel permeation chromatography (GPC) using polystyrene as standard and tetrahydrofuran as mobile phase).

Examples of suitable (meth)acrylate compounds include (meth)acrylic esters and especially acrylic esters of polyhydric alcohols, especially polyhydric alcohols which, besides the hydroxyl groups, contain no further functional groups or at most ether groups. Examples of such alcohols include dihydric alcohols, such as ethylene glycol, propylene glycol and their higher condensed representatives, eg diethylene glycol, triethylene glycol, dipropylene glycol and tripropylene glycol, also 1,3-propanediol, 1,2-butanediol, 1,4-butanediol, 1,2-pentanediol, 1,2-hexanediol, 1,6-hexanediol, neopentylglycol, alkoxylated phenols and bisphenols such as for example ethoxylated bisphenol A, cyclohexanedimethanol. Also suitable are trihydric alcohols such as for example glycerol, trimethylol-propane, 1,2,4-butanetriol, 1,2,3-butanetriol, or trimethylol-ethane. It is finally also possible to use higher alcohols such as for example pentaerythritol, ditrimethylolpropane, dipentaerythritol, sorbitol, mannitol and the corresponding alkoxylated, especially ethoxylated or propoxylated, derivatives.

Alkoxylation products are obtainable in a conventional manner by reacting the aforementioned alcohols with alkylene oxides, especially ethylene oxide or propylene oxide. Useful catalysts include acidic compounds,. for example SbCl₅, or else basic compounds, for example NaOCH₃.

Suitable methacrylate compounds further include polyester (meth)acrylates, polyester (meth)acrylates being the (meth)acrylic esters of polyesterols, which can be saturated or unsaturated.

Suitable polyesterols include for example polyesterols as are preparable by esterification of dicarboxylic acids and polycarboxylic acids, preferably dicarboxylic acids, with polyols. Preferred dicarboxylic acids include succinic acid, glutaric acid, adipic acid, sebacic acid, maleic acid, fumaric acid, phthalic acid, its isomers and hydrogenation products and also esterifiable derivatives, such as anhydrides or dimethyl esters or diethyl esters of the acids mentioned. Suitable polyols include ethylene glycol, propylene glycol, and relatively high condensation products such as diethylene glycol, triethylene glycol, dipropylene glycol, tripropylene glycol, moreover 1,3-propanediol, 1,2-butanediol, 1,4-butanediol, 1,2-pentanediol, 1,2-hexanediol, 1,6-hexanediol and also polyalkylene glycols based on ethylene glycol and propylene glycol.

A suitable process for preparing the abovementioned (meth)acrylate compounds is described, for example, in EP-A-279 303.

Epoxy (meth)acrylates and urethane (meth)acrylates are further useful (meth)acrylate compounds. Epoxy (meth)acrylates are obtainable for example by reaction of epoxidized olefins or mono-, di- or polyglycidyl ethers, such as bisphenol A diglycidyl ether, with (meth)acrylic acid. Urethane (meth)acrylates are especially reaction products of hydroxyalkyl (meth)acrylates with poly- or diisocyanates.

Melamine (meth)acrylates and silicone (meth)acrylates are further suitable (meth)acrylate compounds. (Meth)acrylate compounds may be modified to be nonionic—by attachment of amino groups, for example—or ionic—by attachment of acid groups or ammonium groups, for example—and be used in the form of preferably aqueous dispersions or emulsions (known as such from EP-A 0 704 469 and EP-A 0 012 339).

Furthermore, the (meth)acrylate compounds may be adjusted to the desired viscosity by means of reactive diluents. Examples of suitable reactive diluents include vinyl monomers, especially N-vinyl compounds such as N-vinylpyrrolidone, N-vinylcaprolactam and N-vinylformamide, and vinyl ethers such as ethyl vinyl ether, propyl vinyl ether, butyl vinyl ether, isobutyl vinyl ether, sec-butyl vinyl ether, tert-butyl vinyl ether, amyl vinyl ether, 2-ethylhexyl vinyl ether, dodecyl vinyl ether, octadecyl vinyl ether and cyclohexyl vinyl ether, ethylene monoglycol vinyl ether, ethylene monoglycol divinyl ether, diethylene glycol monovinyl ether, diethylene glycol divinyl ether, triethylene glycol monovinyl ether, triethylene glycol divinyl ether, tetraethylene glycol monovinyl ether, tetraethylene glycol divinyl ether, propylene glycol divinyl ether, polyethylene glycol divinyl ether, ethylene glycol butyl vinyl ether, triethylene glycol methyl vinyl ether, polyethylene glycol methyl vinyl ether, 1,4-butanediol monovinyl ether, 1,4-butanediol divinyl ether, 1,6-hexanediol monovinyl ether, 1,6-hexanediol divinyl ether, cyclohexanedimethanol monovinyl ether, cyclohexanedimethanol divinyl ether, trimethylolpropane monovinyl ether, trimethylolpropane divinyl ether, aminopropyl vinyl ether, diethylaminoethyl vinyl ether, and polytetrahydrofuran divinyl ether, vinyl esters, such as vinyl acetate, vinyl propionate, vinyl stearate and vinyl laurate, and aromatic vinyl compounds, such as vinyltoluene, styrene, 2-butylstyrene, 4-butylstyrene and 4-decylstyrene, and also acrylate monomers, such as phenoxyethyl acrylate, tert-butylcyclohexyl acrylate, 1,6-hexanediol diacrylate, tripropylene glycol diacrylate and trimethylolpropane triacrylate.

Vinyl compounds may also be used directly as cationically polymerizable binders.

As radiation-curable binders there may further be used epoxy compounds, such as cyclopentene oxide, cyclohexene oxide, epoxidized polybutadiene, epoxidized soybean oil, 3′,4′-epoxycyclohexylmethyl 3,4-epoxycyclohexanecarboxylate and glycidyl ethers, eg 1,4-butanediol diglycidyl ether, 1,6-hexanediol diglycidyl ether, bisphenol A diglycidyl ether and pentaerythritol diglycidyl ether, in which case cationically polymerizable monomers, for example unsaturated aldehydes and ketones, dienes such as butadiene or isoprene, aromatic vinyl compounds such as styrene, N-substituted vinylamines such as vinylcarbazole and cyclic ethers such as tetrahydrofuran, may likewise be used as well.

In the particular case where the binder is to be cured by means of UV radiation, it is advisable to apply the binder to the print together with a photoinitiator to initiate the polymerization.

Examples of photoinitiators which are suitable for free-radical photopolymerizations include benzophenone and benzophenone derivatives such as 4-phenylbenzophenone and 4-chlorobenzophenone, acetophenone derivatives such as 1-benzoylcyclohexan-1-ol, 2-hydroxy-2,2-dimethylacetophenone and 2,2-dimethoxy-2-phenylacetophenone, benzoin and benzoin ethers such as methyl benzoin ether, ethyl benzoin ether and butyl benzoin ether, benzil ketals such as benzil dimethyl ketal, 2-methyl-1-[4-(methylthio)phenyl]-2-morpholinopropan-1-one, acylphosphine oxides such as 2,4,6-trimethylbenzoyldiphenylphosphine oxide and bisacylphosphine oxides.

Examples of photoinitiators which are suitable for cationic photopolymerizations include aryldiazonium salts such as 4-methoxybenzenediazonium hexafluorophosphate, benzenediazonium tetrafluoroborate and toluenediazoniumtetrafluoroarsenate, aryl iodonium salts such as diphenyliodonium hexafluoroarsenate, arylsulfonium salts such as triphenylsulfonium hexafluorophosphate, benzenesulfonium hexafluorophosphate, toluenesulfonium hexafluorophosphate and bis[4-diphenylsulfoniophenyl] sulfide bishexafluorophosphate, disulfones such as diphenyl disulfone and phenyl 4-tolyl disulfone, diazodisulfones, imidotriflates, benzoin tosylates, isoquinolinium salts such as N-ethoxyisoquinolinium hexafluorophosphate, phenylpyridinium salts such as N-ethoxy-4-phenylpyridinium hexafluorophosphate, picolinium salts such as N-ethoxy-2-picolinium hexafluorophosphate, ferrocenium salts and titanocenes.

Where the presence of a photoinitiator is required, it is generally used in amounts from 0.1 to 10% by weight, preferably from 0.1 to 8% by weight, based on the weight of the binder.

The subsequent curing of the binder, ie the fixing of the print, can be effected in a conventional manner using high energy radiation when radiation-curable binders are used. To this end, the print is irradiated either with electrons (electron beam curing) under an inert gas (nitrogen, for example) or with high energy electromagnetic radiation, preferably in the wavelength range from 220 to 450 nm. The light intensities which are selected have to be adapted to the rate-of curing to avoid any degradation of the colorant. In the case of a lamp power output of from 210 to 240 W/cm, the rate of curing can be up to 100 m/min, depending on the concentration and type of photoinitiator.

Thermally curable binders are typically crosslinked by polycondensation or polyaddition reactions. These binders are likewise common knowledge and described for example in Glasurit-Handbuch Lacke und Farben der BASF Farben und Fasern AG, Vincentz Verlag, Hannover (1984) and in Lackharze Chemie, Eigenschaften, Anwendungen, Karl Hanser Verlag, Munich/Vienna (1996).

It is particularly useful to use, for example, polycondensation-crosslinkable binders based on acrylates which contain methylol groups.

Examples of preferred systems include mixtures of from 1 to 10% by weight of N-methylol (meth)acrylamide or its C₁-C₄-alkyl ethers and, if desired, monomers which contain halohydrin groups such as 2-hydroxy-3-chloropropylene acrylate and

from 90 to 99% by weight of comonomers selected, for example, from the group consisting of butadiene, styrene, (meth)acrylic acid, (meth)acrylonitrile, (meth)acrylic and vinyl esters having up to 12 carbon atoms, vinyl chloride and N-vinylpyrrolidone, as described for example in DE-A 16 19 656.

Acrylic acid derivatives which contain methylol groups bring about additional crosslinking in the presence of acids or of compounds which detach protons when heated, such as ammonium phosphates.

Examples of air-drying binders where aliphatic double bonds are oxidatively crosslinked by the action of atmospheric oxygen are drying oils such as linseed oil, wood oil and safflower oil.

Useful thermally curable binders further include binders which are based on polyurethane prepolymers and which likewise crosslink by polycondensation.

If the binder, as is preferred in the present invention, is applied in the form of a dispersion or emulsion to the substrates printed with the colorant preparations of the invention, the binder content of these dispersions or emulsions is within the range from 10 to 60% by weight, preferably within the range from 10 to 30% by weight. It is customary to use sufficient binder to form a protective film on the substrate which is from about 1 to 30 μm in thickness when dry.

The areas printed by the ink jet process-are customarily heat treated to fix and develop the dyes. The heating can be effected for example using steam or hot air. A customary temperature range is from 160 to 180° C. for from 5 to 8 minutes. In the case of hot air, it is advisable to treat the printed textile at from 180 to 200° C. for 1 minute.

In a further embodiment of the present invention, development is effected by the action of IR or microwave radiation or of high energy electromagnetic radiation.

In a further version of the present invention, dispersions of the abovementioned radiation-curable, thermally curable or air oxidation drying binders are added to the colorant preparations of the present invention or to the inks of the present invention before printing. The present invention further provides colorant preparations comprising dispersions of the abovementioned binders. The present invention further provides in addition a process for printing substrates by the ink jet process using the colorant preparations of the present invention which were defined at the beginning to which a binder has been added before printing.

Useful substrate materials include:

cellulosics such as paper, paperboard, cardboard, wood and woodbase,

metallic materials such as foils, sheets or workpieces composed of aluminum, iron, copper, silver, gold, zinc or alloys thereof,

silicatic materials such as glass, porcelain and ceramic that may likewise be coated,

polymeric materials of any kind such as polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers and block copolymers, biodegradable polymers and natural polymers such as gelatin,

textile materials such as fibers, yarns, threads, knits, wovens, nonwovens and garments composed of polyester, modified polyester, polyester blend fabrics, cellulosics such as cotton, cotton blend fabrics, jute, flax, hemp and ramie, viscose, wool, silk, polyamide, polyamide blend fabrics, polyacrylonitrile, triacetate, acetate, polycarbonate, polypropylene, polyvinyl chloride, polyester microfibers and glass fiber fabric,

leather—both natural and artificial—in the form of smooth leather, nappa leather or suede leather,

comestibles and cosmetics.

The colorant preparations according to the invention are useful as ink jet inks having altogether advantageous application properties, especially good start-of-print performance and good sustained use performance (kogation) and also, especially when the particularly preferred solvent combination is used, good dry time and produce printed images of high quality, ie of brilliance and depth of shade and also high rub-, light-, water- and wetrubfastness. They are particularly useful for printing coated and uncoated paper and also textile.

A further embodiment of the present invention provides substrates, especially textile substrates, which have been printed by one of the abovementioned processes according to the invention and are notable for particularly crisply printed pictures or drawings.

It has also been determined that the colorant preparations according to the invention are particularly useful for ink jet printing by the transfer process on using disperse dye a1). In the transfer printing process, first the image is printed onto a transfer material, for example onto paper, especially paper from Coldenhove (Netherlands) and Cam Tenero (Switzerland) specifically manufactured for this process, and transferred from there, by means of heat, to substrates, for example to substrates composed of textile. A further embodiment of the present invention accordingly provides a process for printing substrates, preferably textile substrates, by the transfer printing process using the colorant preparations according to the invention and also substrates, preferably textile substrates, printed by the transfer printing process using the colorant preparations according to the invention. The colorant preparations for the transfer printing process are preferably produced on the basis of a disperse dye. Particular preference is given to preparing the inks for the transfer printing process on the basis of the following colorants:

Disperse Yellow 54,

Disperse Red 11, 60,

Disperse Blue 72, 289, 326, 332, 347, 359;

Disperse Violet 17.

The colorant preparations according to the invention are lastly very useful as an ink for fountain pens or for preparing inks for fountain pens. A further aspect of the present invention is therefore the use of the colorant preparations according to the invention as or in inks for fountain pens and also inks for fountain pens comprising the colorant preparations according to the invention. The colorant preparations can either be filled into common ink bottles or ink cartridges immediately after production or else be diluted with common additives.

The inks thus obtainable are notable for an excellent performance profile. There may be mentioned by way of example an excellent dry time and the observation that the inks flow freely from the line, ensuring very uniform application to paper for example.

### EXAMPLES

### Preparation of Inventive Colorant Preparations

1st Step: Preparation of Dispersant C2-A

Dispersant C2-A was prepared in the same way as “Dispersant 4” in U.S. Pat. No. 5,186,846.

A cracker fraction of the following composition (Table 1a) was used as a starting material:

TABLE 1A

| | % by weight in |
|---|---|
| | aromatics fraction |
| Naphthalene | 54.60 |
| 2-Methylnaphthalene | 14.00 |
| 1-Methylnaphthalene | 8.30 |
| Indene | 8.40 |
| Biphenyl | 3.20 |
| Methylindene | 1.95 |
| Acenaphthene | 1.70 |
| Fluorene | 1.30 |
| Indan | 1.22 |
| Phenanthrene | 1.10 |
| Methylindan (mixed isomers) | 1.13 |
| Ethylnaphthalene (mixed isomers) | 0.90 |
| para- and meta-Xylene | 0.80 |
| Tetralin | 0.80 |
| Styrene | 0.60 |

128 g of the cracker fraction were mixed with 25 g of benzoic acid and heated to 90° C. in a kettle. 107 g of oleum having an SO₃ content of 65% by weight were then added over a period of 2 hours, during which care was taken to ensure that the temperature did not exceed 95° C. On completion of the oleum addition the batch was heated to 140° C. and stirred at 140° C. for about 3½ hours. This was followed by cooling to 80° C., and the addition of 150 ml of water, followed by 50 g of 30% by weight formalin solution. The ensuing condensation reaction was continued at 100° C. for 8 hours.

½ l of water was then added, followed by 131 g of 50% by weight aqueous sodium hydroxide solution. The mixture was stirred at 90° C. for one hour. A further 365 ml of water were then added before a pH of 8.4 was set with 20% by weight H₂SO₄. The C2-B product was lastly isolated by spray drying in a spray tower.

The product comprised the following characteristic parameters: α-: β-naphthalenesulfonic acid 1:4.5, Na₂SO₄ content: 1.5% by weight.

2nd Step: Preparation of Mix Component

In a dissolver, 12.5 g of Tectilon® Blue Base 6G (commercially available from Ciba Specialties) were mixed with 6.25 g of Pluriol E 400® (commercially available from BASF Aktiengesellschaft), C2-A dispersant, 0.3 g of biocide A and 0.4 g of biocide B with 0.5 g of triethanolamine and made up with 67.55 ml of demineralized water. This mixture was ball milled for 5 hours to a maximum particle diameter of 1 μm.

The composition of these and further, similarly prepared mix components is evident from Table 2. All input materials are reported in grams.

TABLE 2

| Input material | Turquoise | Yellow | Red | Blue 1 | Blue 2 |
|---|---|---|---|---|---|
| Inthratherm Blue | | | | | 12.5 |
| P-305 NT | | | | | |
| Quinone Blue PM | | | | 12.5 | |
| Palanil Red BFW-L | | | 15 | | |
| Palanil ® Yellow 3GE | | 15 | | | |
| Tectilon ® Blue | 12.5 | | | | |
| Pluriol E 400 ® | 6.25 | 15 | 7.5 | 12.5 | 12.5 |
| C2-A | 12.5 | 7.5 | 15 | 6.25 | 6.25 |
| Biocide A | 0.3 | 0.4 | 0.4 | 0.3 | 0.3 |
| Biocide B | 0.4 | 0.5 | 0.5 | 0.4 | 0.4 |
| Triethanolamine | 0.5 | 0.5 | 0.5 | 0.5 | 0.5 |
| DM water | 67.55 | 61.1 | 61.1 | 67.55 | 67.55 |

3rd Step: Formulation of a Highly Concentrated Ink

In a beaker, 32.0 g of a turquoise mix component prepared according to 2. were admixed with 5.0 g of compound I a 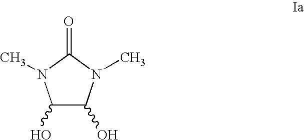
and further mixed with 10 g of glycerol, 3 g of Pluriol E 400®, 1 g of Pluriol E 4000®, 0.5 g of Biocide D, 0.1 g of triethanolamine, 0.2 g of Tego Wet 260® and 48.2 ml of DM water.

The compositions of further inks are evident from Table 3 (see hereinbelow).

TABLE 3
Formulations of inks

| | Ink 1 | Ink 2 | Ink 3 |
|---|---|---|---|
| Ingredient | (turquoise) | (turquoise) | (turquoise) |
| Mix component | 32.0 | 32.0 | 32.0 |
| Compound Ia | 5.0 | 5.0 | 5.0 |
| Pluriol E 400 | 3.0 | 3.0 | 3.0 |
| Pluriol E 4000 | 1.0 | 1.0 | 1.0 |
| Glycerol | 10.0 | | |
| 1,2-Pentanediol | | 10.0 | |
| 1,2-Propanediol | | | 10.0 |
| Biocide D | 0.5 | 0.5 | 0.5 |
| Tego Wet 260 | 0.2 | 0.2 | 0.2 |
| Triethanolamine | 0.1 | 0.1 | 0.1 |
| DM water [ml] | 48.2 | 48.2 | 48.2 |
| Viscosity [mm²/s] | 2.537 | 2.814 | 2.688 |

All components in g, unless otherwise stated. The viscosities were determined in accordance with DIN 51662 using an Ubbelohde viscometer.

Biocide A is a 50% by weight aqueous solution of glutaraldehyde.

Biocide B is a 4% by weight aqueous solution of tetramethylolacetylenediurea.

Biocide C is a 20% by weight solution of 1,2-benzisothiazolon-3-one in aqueous ethylene glycol.

Biocide D is a 10% by weight solution of 1,2-benzisothiazolon-3-one in aqueous propylene glycol.

The wetting agent is 2-(3-hydroxypropyl)heptamethyltrisiloxane, initially ethoxylated and then propoxylated (11 mol of ethylene oxide/5 mol of propylene oxide).

4th Step

The ink obtained in step 3 was printed onto A3 paper using an EPSON 3000 Stylus Color thermal head printer. The prints obtained had excellent line crispness. There was no nozzle failure after 40 sheets of paper, nor after 5 m² of printing. The prints obtained after the ink was left to stand at room temperature for 6 days were likewise excellent and free of stripes.

Inks 4 and 5 and also comparative examples V1 to V4 (dilute inks)

The inks recited in Table 4 were formulated in a beaker starting from the mix components Turquoise and Blue 2 (see step 2).

The comparative examples utilized the following urea derivatives

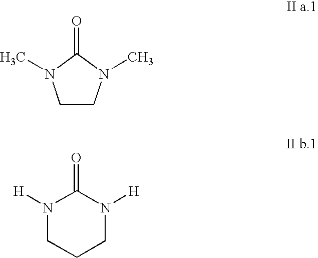

in place of I a.

TABLE 4
Compositions of dilute inks

| Ingredients | Ink 4 | Ink 5 | Ink V1 | Ink V2 | Ink V3 | Ink V4 |
|---|---|---|---|---|---|---|
| Turquoise | | 10.0 | | | 10.0 | 10.0 |
| mix | | | | | | |
| component | | | | | | |
| Blue I mix | 10.0 | | 10.0 | 10.0 | | |
| component | | | | | | |
| Glycerol | 8.0 | 8.0 | 8.0 | 8.0 | 8.0 | 8.0 |
| Pluriol | 3.0 | 3.0 | 3.0 | 3.0 | 3.0 | 3.0 |
| E 400 ® | | | | | | |
| Pluriol | 1.0 | 1.0 | 1.0 | 1.0 | 1.0 | 1.0 |
| E 4000 ® | | | | | | |
| Dispersant | 2.0 | 2.0 | 2.0 | 2.0 | 2.0 | 2.0 |
| C2-A | | | | | | |
| Tego Wet | 0.1 | 0.1 | 0.1 | 0.1 | 0.1 | 0.1 |
| 260 ® | | | | | | |
| Biocide D | 0.48 | 0.48 | 0.48 | 0.48 | 0.48 | 0.48 |
| Triethanolamine | 0.05 | 0.05 | 0.05 | 0.05 | 0.05 | 0.05 |
| DM water | 85.37 | 85.37 | 85.37 | 85.37 | 85.37 | 85.37 |
| [ml] | | | | | | |
| Intermediate | 100.0 | 100.0 | 100.0 | 100.0 | 100.0 | 100.0 |
| total | | | | | | |
| I a | 5.0 | 5.0 | | | | |
| II a.1 | | | 5.0 | 5.0 | | |
| II b.1 | | | | | 5.0 | 5.0 |
| Grand total | 105.0 | 105.0 | 105.0 | 105.0 | 105.0 | 105.0 |

All amounts reported in g, unless otherwise stated.

The inks were printed onto A3 paper of the Coldenhove HTR 2000 brand using an Epson 3000 Stylus Color printer. Print quality was good in each case.

The inks were aged at 60° C. for 5 days before the printing trials were repeated.

The prints prepared using the inks according to the invention exhibited very good contours and uniformly brilliantly colored areas.

The prints prepared using the comparative inks appeared less uniform and contours were not as good. Examined under a microscope at 75-fold magnification, the colorant was seen to be present in the form of comparatively large circular crystals when the V2 and V4 comparative inks were used. When the V1 and V3 comparative inks were used, the onset of phase separation was observed.

### Examples of the Use as a Fountain Pen Ink

The 4, V1 and V2 inks were each filled into ink cartridges and written onto papers of the brands Coldenhove HTR 2000, Neusiedler Color Copy, Epson Super Fine Paper®, HP Premium InkJet Glossy Paper® and Motiv Copy Paper using a Parker Frontier® fountain pen. Straight lines were drawn for comparison. The lines drawn using ink 4 according to the invention had a completely uniform width, while the V1 and V2 comparative inks did not exhibit uniform width and even showed some interruptions on Motiv Copy Paper.

1: Colorant preparations comprising
a) at least one colorant selected from sparingly water-soluble colorants a1) and water-soluble dyes a2),
b) water,
c) at least one dispersant in the case of substantially water-insoluble or sparingly water-soluble colorants a1), and
d) at least one compound of formula I 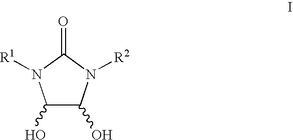
where
R¹ and R² are independently selected from hydrogen,
C₁-C₄-alkyl and
CH₂—O—R³, where
R³ is hydrogen or C₁-C₄-alkyl.

2: Colorant preparations as claimed in claim 1, wherein R¹ and R² are the same.

3: Colorant preparations as claimed in claim 1, wherein R¹ and R² are each methyl or hydrogen.

4: Colorant preparations as claimed in claim 1, wherein said dispersant c) comprises arylsulfonic acid-formaldehyde condensation products.

5: Colorant preparations as claimed in claim 1, comprising said colorant a1); wherein said colorant a1) is a dispersed pigment, a dispersed disperse dye or a solvent dye.

6: A process for printing substrates by the ink jet process, which comprises using colorant preparations as claimed in claim 1.

7: A process as claimed in claim 6, wherein the print is fixed after the actual printing.

8: A process as claimed in claim 7, wherein a binder in the form of a dispersion or emulsion is applied to the printed substrate after the actual printing.

9: A process as claimed in claim 7, wherein a dispersion or emulsion of a thermally curable binder, of an air-drying binder or of a radiation-curable binder, said dispersion or emulsion optionally further comprising a photoinitiator, or a physically drying binder dispersion or emulsion is applied for fixation.

10: A process as claimed in claim 7, wherein said binder is cured by the action of IR radiation, electron beam radiation or high energy electromagnetic radiation.

11: A process as claimed in claim 7, wherein a film is laminated onto the print after the actual printing.

12: A process for printing substrates, which comprises:
transfer printing the colorant preparations of claim 1 to the substrate.

13: A process for printing substrates by the ink jet process using colorant preparations as claimed in claim 1, which comprises
adding a binder to the colorant preparations before printing.

14: Substrates printed by a process as claimed in claim 6.

15: The use of colorant preparations as claimed in claim 1 as or in inks for fountain pens.

16: A process for printing one or more textile substrate, which comprises:
transfer printing the colorant preparation as claimed in claim 1 to the textile substrate.

17: A fountain pen, which comprises:
the colorant preparation as claimed in claim 1 or
an ink comprising the colorant preparation.
